(19) United States
(12) Patent Application Publication
(10) Pub. No.: US 2017/0124519 A1
(43) Pub. Date: May 4, 2017

(54) MEETING BASED CREDENTIAL PROVISIONING

(71) Applicant: Aerohive Networks, Inc., Sunnyvale, CA (US)

(72) Inventors: John William Hanay, Palo Alto, CA (US); Michael Isamu Lee, San Jose, CA (US); Ngan My Bich Huynh, Campbell, CA (US)

(73) Assignee: AEROHIVE NETWORKS, INC., Sunnyvale, CA (US)

(21) Appl. No.: 14/883,425

(22) Filed: Oct. 29, 2015

(51) Int. Cl. G06Q 10/10

(52) U.S. Cl. CPC G06Q 10/1095

(57) ABSTRACT

Meeting based credential provisioning including gathering meeting data regarding a meeting. A plurality of meeting attendees of the meeting is determined from the meeting data. Meeting attendees of the plurality of meeting attendees to distribute credentials to for accessing a wireless network as part of the meeting are verified. A credential list indicating the meeting attendees to distribute the credentials to for accessing a wireless network as part of the meeting is created and submitted. The credentials are distributed to the meeting attendees using the credential list based on submission of the credential list.

### BACKGROUND

An area of ongoing research and development is credential provisioning. In particular, there exists a need for credential provisioning related to meetings.

There therefore exists a need for credential provisioning related to schedule meetings.

The foregoing examples of the related art and limitations related therewith are intended to be illustrative and not exclusive. Other limitations of the relevant art will become apparent to those of skill in the art upon reading the specification and studying of the drawings.

### SUMMARY

The following implementations and aspects thereof are described and illustrated in conjunction with systems, tools, and methods that are meant to be exemplary and illustrative, not necessarily limiting in scope. In various implementations one or more of the above-described problems have been addressed, while other implementations are directed to other improvements.

In various implementations meeting based credential provisioning is provided. In various implementations, meeting data regarding a meeting is gathered. Further, in various implementations, a plurality of meeting attendees of the meeting is determined from the meeting data. In various implementations, meeting attendees of the plurality of meeting attendees to distribute credentials to for accessing a wireless network as part of the meeting are verified. Additionally, in various implementations, a credential list indicating the meeting attendees to distribute the credentials to for accessing a wireless network as part of the meeting is created and submitted. In various implementations, the credentials are distributed to the meeting attendees using the credential list based on submission of the credential list.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of a system for providing network credentials to a meeting attendee.

FIG. 2 depicts a diagram of an example of an ID Management (IDM) exchange manager system for managing meetings in providing credentials to attendees.

FIG. 3 depicts a diagram of an example of system for managing provisioning of credentials to meeting attendees in accessing a wireless network as part of a meeting.

FIG. 4 depicts a diagram of a flowchart of an example method for distributing credentials to meeting attendees for accessing a wireless network associated with a meeting.

FIG. 5 depicts a diagram of a flowchart of an example method for distributing credentials to meeting attendees for accessing a wireless network associated with a meeting using a credential record.

FIG. 6 depicts a flowchart of an example of a method for generating a credential list based on feedback from a meeting organizer for the purposes of providing credentials to meeting attendees in accessing a wireless network as part of a meeting.

FIG. 7 depicts a flowchart of an example of a method for verifying meeting attendees to distribute credentials to for purposes of accessing a wireless network as part of a meeting. The flowchart begins at module, where meeting data for a meeting is gathered.

FIG. 8 depicts a diagram of an example of a system for distributing credentials to meeting attendees for use in accessing a wireless network as part of a meeting.

### DETAILED DESCRIPTION

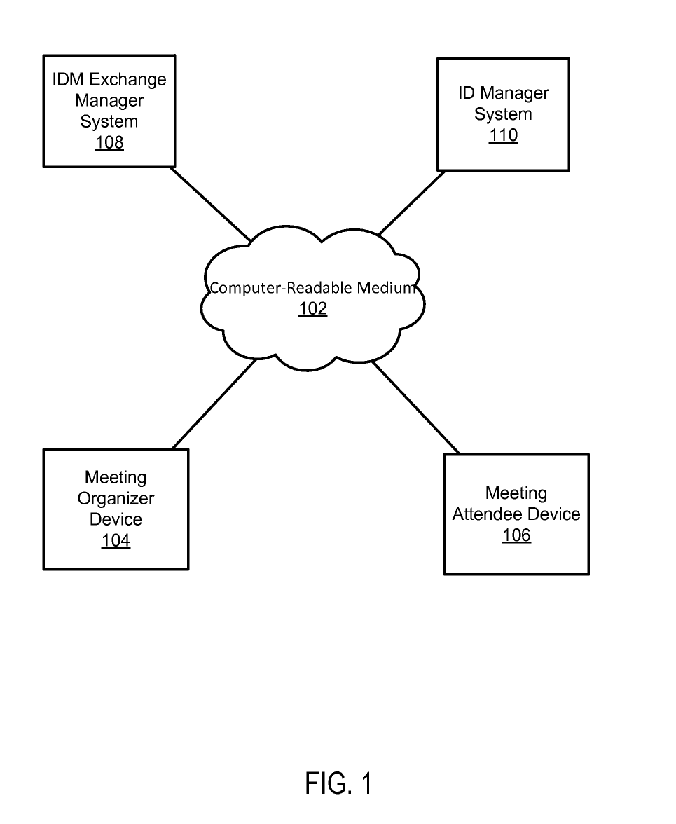

FIG. 1 depicts a diagram 100 of a system for providing network credentials to a meeting attendee. The example system shown in FIG. 1 includes a computer-readable medium 102, a meeting organizer device 104, a meeting attendee device 106, an ID Management (IDM) manager system 108, and an ID manager system 110.

In the example system shown in FIG. 1, the meeting organizer device, the meeting attendee device 106, the IDM manager system 108, and the ID manager system 110 are coupled to each other through the computer-readable medium 102. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The computer-readable medium 102, the meeting organizer device 104, the meeting attendee device 106, the IDM exchange manager system 108, the ID manager system 110, and other applicable systems or devices described in this paper can be implemented as a computer system, a plurality of computer systems, or parts of a computer system or a plurality of computer systems. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, Ethernet interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

The meeting organizer device 104 functions according to an applicable device for sending and receiving data related to meetings. The meeting organization device 104 can be used to schedule and organize a meeting. In scheduling and organizing a meeting, the meeting organizer device 104 can send and receive meeting data. Meeting data can include applicable data related to scheduling and organizing a meeting, such as a time and a location of a meeting, invites to invitees of a meeting, contact information of invitees, confirmation of invitees who will attend a meeting, lists of attendees of a meeting, and communication addresses of invitees and/or attendees of a meeting. Meeting data can also include indications of whether or not to create and distribute credentials to meeting attendees in accessing a wireless network as part of or during a meeting. Depending upon implementation-specific or other considerations, the meeting organizer device 104 can calendar a meeting created by an organizer. For example, the meeting organizer device 104 can create an entry in a calendar for a meeting created by the organizer.

In a specific implementation, the meeting organizer device 104 functions to send invites to request to attend a meeting. The meeting organizer device 104 can send out invites to communication addresses, e.g. email addresses, of invitees. Invites sent out by the meeting organizer device 104 can include functionalities that upon activation cause a meeting to be calendared in a calendar of an invitee. Depending upon implementation-specific or other considerations, the meeting organizer device 104 can receive confirmation of invitees who will attend a meeting. Confirmation of invitees who will attend a meeting can be used by the meeting organizer device 104 to generate meeting data. For example the meeting organizer device 104 can use confirmations of invitees to generate a list of attendees to a meeting.

The meeting attendee device 106 functions according to an applicable device for sending and receiving data related to meetings. The meeting attendee device 104 can be used to schedule a meeting for an attendee. In scheduling a meeting for an attendee, the meeting attendee device 106 can send and receive meeting data. For example, the meeting attendee device 106 can receive an invite to a meeting and send a response indicating whether an invitee will attend the meeting. Depending upon implementation-specific or other considerations, the meeting attendee device 106 can calendar a meeting an invitee has agreed to attend. For example, the meeting attendee device 106 can create an entry in a calendar of an attendee for a meeting the attendee has agreed to attend.

In a specific implementation, either or both the meeting organizer device 104 and the meeting attendee device 106 act as or include a station, by including a wireless interface through which they can be coupled through a Wi-Fi connection to a network device. A station, as used in this paper, can be referred to as a device with a media access control (MAC) address and a physical layer (PHY) interface to a wireless medium that complies with the IEEE 802.11 standard. Thus, for example, the first client device 104 and the second client device 106 can be referred to as stations, if applicable. IEEE 802.11a-1999, IEEE 802.11b-1999, IEEE 802.11g-2003, IEEE 802.11-2007, IEEE 802.11n TGn Draft 8.0 (2009), and IEEE 802.11ac-2013 are incorporated by reference. As used in this paper, a system that is 802.11 standards-compatible or 802.11 standards-compliant complies with at least some of one or more of the incorporated documents' requirements and/or recommendations, or requirements and/or recommendations from earlier drafts of the documents, and includes Wi-Fi systems. Wi-Fi is a non-technical description that is generally correlated with the IEEE 802.11 standards, as well as Wi-Fi Protected Access (WPA) and WPA2 security standards, and the Extensible Authentication Protocol (EAP) standard. In alternative embodiments, a station may comply with a different standard than Wi-Fi or IEEE 802.11, may be referred to as something other than a “station,” and may have different interfaces to a wireless or other medium.

The IDM exchange manager system 108 functions to manage a meeting created by an organizer. In managing a meeting created by an organizer, the IDM exchange manager system 108 can send and receive meeting data. Depending upon implementation-specific or other considerations, the IDM exchange manager system 108 can send and receive meeting data using an organizer of a meeting. For example, the IDM exchange manager system 108 can access an email account of an organizer to determine invitees to a meeting and specific invitees who have confirmed that they will attend the meeting. The IDM exchange manager system 108 can manage a meeting created by an organizer for purposes of generating credentials for meeting attendees to use in accessing a wireless network. For example, the IDM exchange manager system 108 can manage a meeting to determine attendees for a meeting and whether the attendees will need to have credentials created for accessing a wireless network. Depending upon implementation-specific or other considerations, the IDM exchange manager system 108 can manage a meeting for purposes of generating credentials for meeting attendees to access a wireless network at a location of a meeting. For example, the IDM exchange manager system 108 can manage a meeting for purposes of attendees accessing an organization's wireless network on-premises of the organization. In another example, the IDM exchange manager system 108 can manage a meeting for purposes of attendees accessing an organization's wireless network off-premises of the organization.

In a specific implementation, the IDM exchange manager system 108 can manage a credential list for purposes of generating credentials for meeting attendees to use in accessing a wireless network. A credential list, represented by credential list data, can indicate attendees of a meeting, specific attendees to create credentials for in accessing a wireless network, and an address of an attendee or an attendee device. For example, a credential list can include an email address of an attendee. Depending upon implementation-specific or other considerations, the IDM exchange manager system 108 can manage a credential list based on meeting data sent by a meeting organizer. For example, the IDM exchange manager system 108 can generate a credential list that includes all invitees to a meeting, or all invitees to a meeting who confirmed that they will attend the meeting. Further depending upon implementation-specific or other considerations, the IDM exchange manager system 108 can manage a credential list by communicating with a meeting organizer. For example, the IDM exchange manager system 108 can ask a meeting organizer to identify meeting attendees that will need credentials for accessing a wireless network. In another example, IDM exchange manager system 108 can receive deny requests from a meeting organizer indicating specific meeting attendees to refrain from creating credentials for, and thereby exclude the specific meeting attendees from a credential list.

In a specific implementation, the IDM exchange manager system 108 submits a credential list for use in generating credentials for meeting attendees to use in accessing a wireless network. Depending upon implementation-specific or other considerations, the IDM exchange manager system 108 can submit a credential list at a set time. For example, the IDM exchange manager system 108 can submit a credential list 15 minutes before a meeting is scheduled to take place. Further depending upon implementation-specific or other considerations, the IDM exchange manager system 108 can submit a credential list after occurrence of a specific event. For example, the IDM exchange manager system 108 can submit a credential list after all invitees to a meeting have either accepted or denied an invitation to the meeting.

In a specific implementation, the IDM exchange manager system 108 communicates with a meeting organizer after credentials have been sent to attendees. Depending upon implementation-specific or other considerations, the IDM exchange manager system 108 can inform a meeting organizer that credentials have been sent to attendees after the credentials have been sent. For example, the IDM exchange manager system 108 can send a list of attendees that were sent credentials to a meeting organizer. Further depending upon implementation-specific or other considerations, the IDM exchange manager system 108 can query an organizer if they want credentials to be resent to an attendee. If a meeting organizer, in response to a query, indicates that they want credentials resent to a specific meeting attendee, then the IDM exchange manager system 108 can instruct an applicable system for generating credentials in accessing a wireless network to resend the credentials to the specific meeting attendee.

The ID manager system 110 functions to manage credentials used in accessing a wireless network. In managing credentials used in accessing a wireless network, the ID manager system 110 can generate credentials used in accessing a wireless network. Further, in managing credentials used in accessing a wireless network, the ID manager system 110 can distribute credentials to attendees of a meeting.

In a specific implementation, the ID manager system 110 maintains a credential record based on credentials generated for and distributed to specific meeting attendees. A credential record can indicate an identification of an attendee, whether credentials have been generated for and distributed to specific attendees, what specific credentials have been distributed to what specific attendees, expirations dates of credentials given to attendees. Depending upon implementation-specific or other considerations, a credential record can be used by a network device, e.g. an access point, to authenticate a device of an attendee for accessing a wireless network. For example, a network device can determine, from a credential record, a specific credential assigned to an attendee and subsequently authenticate a device of the specific attendee if a credential received from the device of the specific attendee matches the specific credential. Further depending upon implementation-specific or other considerations, the ID manager system 110 can use a credential record to determine whether a specific attendee needs to have a new credential distributed to them. For example, the ID manager system 110 can check a credential record to see if an attendee has been distributed a credential that has subsequently expired and distribute a valid credential the attendee if their credential has expired.

In a specific implementation, the ID manager system 110 generates and distributes credentials to meeting attendees according to a credential list. For example, if a credential list indicates to create a credential for a specific attendee, then the ID manager system 110 can generate the credential for the specific attendee. The ID manager system 110 can use a credential list to distribute credentials. For example, the ID manager system 110 can send credentials to addresses of attendees devices, included as part of a credential list.

In a specific implementation, the ID manager system 110 determines a credential validity length of credentials sent to meeting attendees. In determining credential validity length, the ID manager system 110 can determine a credential validity length of a credential distributed to a specific meeting attendee and update a credential record to indicate the determined credential validity length. Depending upon implementation-specific or other considerations, the ID manager system 110 can determine a credential validity length based on input received from a meeting attendee. For example, a meeting organizer can input that a credential is valid for one week, and the ID manager system 110 can determine that a the credential for a specific attendee is only valid for one week. Further depending upon implementation-specific or other considerations, the ID manager system 110 can determine credential validity length based on meeting data for a meeting. For example, the ID manager system 110 can determine a credential validity length of an attendee of a meeting is as long as the meeting.

In a specific implementation, the ID manager system 110 functions to resend credentials generated for a meeting attendee. Depending upon implementation-specific or other considerations, the ID manager system 110 can resend credentials generated for a meeting attendee in response to instructions from a meeting organizer. For example, a meeting organizer can activate a link to generate instructions to resend credentials to specific meeting attendees, and the ID manager system 110 can resend the credentials in response to the instructions. Further depending upon implementation-specific or other considerations, the ID manager system 110 can resent credentials generated for meeting attendees in response to an occurrence of a specific event. Examples of a specific event can include, a passing of a certain time before a meeting is scheduled to begin, whether a meeting attendee requests for credentials to be resent, whether a meeting attendee has not confirmed receipt of credentials. For example, if the ID manager system 110 fails to receive confirmation that a meeting attendee has received distributed credentials, then the ID manager system 110 can resend the credentials fifteen minutes before a meeting is scheduled to begin.

In a specific implementation, the ID manager system 110 functions to confirm receipt of distributed credentials by attendees. The ID manager system 110 can confirm receipt of distributed credentials based on whether credentials are successfully transmitted to attendees. In confirming receipt of distributed credentials by attendees, the ID manager system 110 can alert applicable systems or parties, e.g. a meeting organizer, that the credentials have been successfully distributed to the attendees.

In an example of operation of the example system shown in FIG. 1, the meeting organizer device 104 and the meeting attendee device 106 send and receive meeting data used in scheduling and confirming attendance to a meeting organized by a meeting organizer. In the example of operation of the example system shown in FIG. 1, the IDM exchange manager system 108 generates a credential list indicating meeting attendees to receive credentials based on meeting data received from the meeting organizer device 104. Further, in the example of operation of the example system shown in FIG. 1, the ID manager system 110 generates and distributes credentials to meeting attendee devices, including the meeting attendee device 106, based on the credential list generated by and received from the IDM exchange manager system 108.

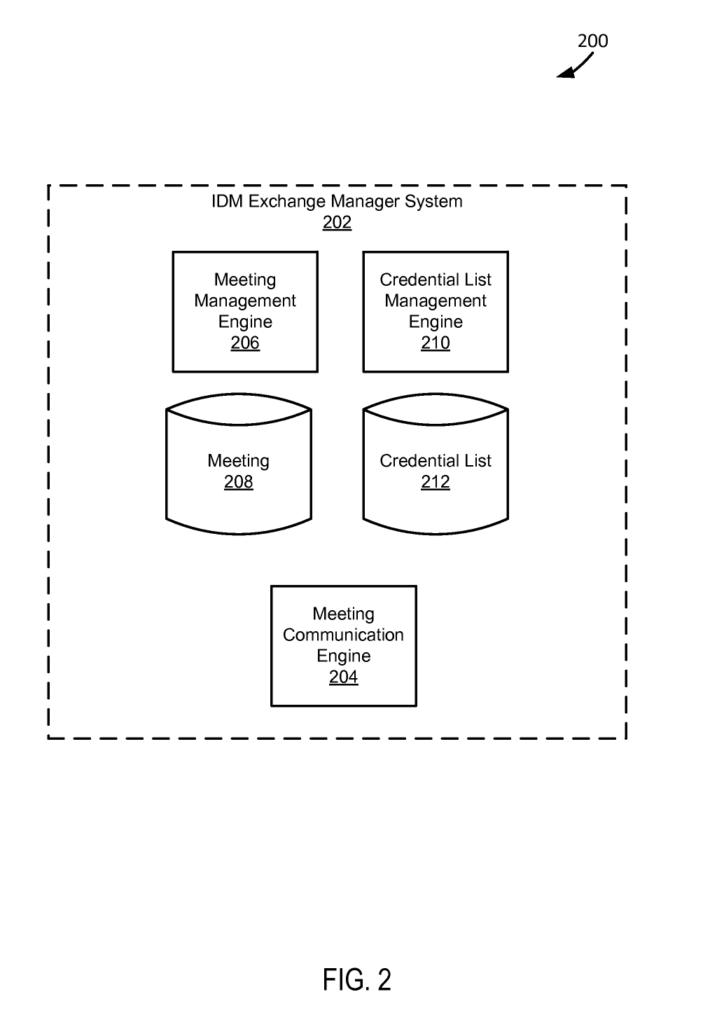

FIG. 2 depicts a diagram 200 of an example of an IDM exchange manager system for managing meetings in providing credentials to attendees. The example system shown in FIG. 2 includes an IDM exchange manager system 202. The IDM exchange manager system 202 functions according to an applicable system for managing meetings in providing credentials to attendees, such as the IDM exchange manager systems described in this paper. In managing meetings, the IDM exchange manager system 202 can receive meeting data from applicable systems or devices, such as meeting organizer devices and meeting attendee devices. Further, in managing meetings, the IDM exchange manger system 202 can maintain a credential list identifying meeting attendees to distribute credentials for in accessing a wireless network as part of a meeting.

In the example system shown in FIG. 2, the IDM exchange manager system 202 includes a meeting communication engine 204, a meeting management engine 206, a meeting datastore 208, a credential list management engine 210, and a credential list datastore 212. The meeting communication engine 204 functions to transmit and receive data used in organizing a meeting for generating and deploying credentials for meeting attendees to access a wireless network associated with the meeting. Depending upon implementation-specific or other considerations, the meeting communication engine 204 can receive or retrieve meeting data from an applicable device or system for generating or transmitting meeting data, such as the meeting organizer devices and meeting attendee devices described in this paper. For example, the meeting communication engine 204 can access an email account of a meeting organizer to determine which invitees will attend a meeting. In another example, the meeting communication engine 204 can query a meeting organizer with messages used in determining which meeting attendees to issue credentials to for accessing a wireless network associated with a meeting.

The meeting management engine 206 functions to manage a meeting for purposes of providing credentials to meeting attendees. In managing a meeting for purposes of providing credentials to meeting attendees, the meeting management engine 206 can determine which invitees to a meeting have indicated that they will attend the meeting and contact information of such invitees, e.g. MAC addresses or IP addresses of devices used by the invitees. Further, in managing a meeting for purposes of providing credentials to meeting attendees, the meeting management engine 206 can determine which meeting attendees need to have credentials distributed to them for accessing a wireless network as part of a meeting. For example, the meeting management engine 206 can determine that a specific meeting attendee is denied credentials and therefore does not need to have credentials distributed to them.

In a specific implementation, the meeting management engine 206 uses meeting data to manage a meeting for purposes of providing credentials to meeting attendees. Depending upon implementation-specific or other considerations, the meeting management engine 206 can manage a meeting for purposes of providing credentials to meeting attendees through meeting data sent by or retrieved from a meeting organizer, a meeting invitee, and/or a meeting attendee. For example, the meeting management engine 206 can access an email account of a meeting organizer to determine meeting invitees and the meeting invitees who confirmed that they will attend a meeting. In another example, the meeting management engine 206 can access meeting attendance responses of meeting invitees to determine which meeting invitees will be attending a meeting.

In a specific implementation, the meeting management engine 206 communicates with a meeting organizer to manage a meeting for purposes of providing credentials to meeting attendees. The meeting management engine 206 can communicate with a meeting organizer using an applicable communication engine, such as the meeting communication engines described in this paper. Depending upon implementation-specific or other considerations, the meeting management engine 206 can communicate with a meeting organizer to confirm meeting attendees for a meeting, and subsequently create meeting data to indicate such confirmation. For example, the meeting management engine 206 can send a determined list of invitees to a meeting and attendees to the meeting to a meeting organizer to confirm meeting attendees. Further depending upon implementation-specific or other considerations, the meeting management engine 206 can communicate with a meeting organizer to determine meeting attendees that will need to be distributed credentials for accessing a wireless network as part of a meeting, and subsequently create meeting data to indicate such meeting attendees. For example, the meeting management engine 206 can send queries to a meeting organizer with links that upon activation indicate deny requests for denying distribution of credentials to specific meeting attendees.

In a specific implementation, the meeting management engine 206 functions to communicate with a meeting organizer regarding progress in distributing credentials to meeting attendees. The meeting management engine 206 can inform a meeting manager whether a credential has been distributed successfully to meeting attendees. Depending upon implementation-specific or other consideration, the meeting management engine 206 can query a meeting organizer with whether they want to resend credentials to a meeting attendee. The meeting management engine 206 can instruct an applicable system, such as the ID manager systems described in this paper, to resent credentials to a meeting attendee in response to input received from an organizer.

The meeting datastore 208 functions to store meeting data related to providing credentials to meeting attendees. Meeting data stored in the meeting datastore 208 can include lists of invitees to a meeting, lists of attendees to a meeting, indicators specifying which attendees will need credentials, communication information through which attendees can be distributed credentials. Depending upon implementation-specific or other considerations, meeting data stored in the meeting datastore 208 can be sent by or retrieved from a meeting organizer, a meeting invitee, and/or a meeting attendee. For example, meeting data stored in the meeting datastore 208 can include meeting data retrieved by accessing an email account of a meeting organizer. Further depending upon implementation-specific or other considerations, meeting data stored in the meeting datastore 208 can be generated based on communication with a meeting organizer. For example, meeting data stored in the meeting datastore 208 can include meeting attendees confirmed by a meeting organizer from a list of meeting attendees determined from meeting data collected from an organizer's email.

The credential list management engine 210 functions to manage a credential list used in providing network credentials to meeting attendees for accessing a wireless network associated with a meeting. In managing a credential list, the credential list management engine 210 can create a credential list. A credential list created by the credential list management engine 210 can include identifications of meeting attendees to distribute credentials to and communication information used in distributing the credentials to devices of the meeting attendees. Further, in managing a credential list, the credential list management engine 210 can remove meeting attendees from the credential list. The credential list management engine 210 can remove meeting attendees from a credential list based on input indicating that the meeting attendees should not have credentials distributed to them. For example, the credential list management engine 210 can create a credential list that includes all meeting attendees and subsequently remove specific meeting attendees based on input from a meeting organizer.

In a specific implementation, the credential list management engine 210 manages a credential list according to meeting data. Depending upon implementation-specific or other considerations, the credential list management engine 210 can manage a credential list using meeting data sent by or retrieved from a meeting organizer, a meeting invitee, and/or a meeting attendee. For example, the credential list management engine 210 can use credential data retrieved from a meeting organizer's email to generate a credential list including all meeting attendees. Further depending upon implementation-specific or other considerations, the credential list management engine 210 can manage a credential list using meeting data generated based on communication with a meeting organizer. For example, the credential list management engine 210 can use input of a meeting organizer indicating which meeting attendees who do not need credentials to remove the meeting attendees from a credential list.

In a specific implementation, the credential list management engine 210 submits a credential list to an applicable system for managing credentials used in accessing a wireless network as part of a meeting, such as the ID manager systems described in this paper. Depending upon implementation-specific or other considerations, the credential list management engine 210 can submit a credential list at a set time. For example, the credential list management engine 210 can submit a credential list 15 minutes before a meeting is scheduled to take place. Further depending upon implementation-specific or other considerations, the credential list management engine 210 can submit a credential list after occurrence of a specific event. For example, the credential list management engine 210 can submit a credential list after all invitees to a meeting have either accepted or denied an invitation to the meeting.

The credential list datastore 212 functions to store credential list data indicating a credential list used in providing credentials to meeting attendees in accessing a wireless network as part of a meeting. The credential list datastore 212 can store credential list data indicating a credential list created from gathered meeting data or generate meeting data. For example, credential list data stored in the credential list datastore 212 can be created based on input from a meeting organizer indicating verified meeting attendees.

In an example of operation of the example system shown in FIG. 2, the meeting communication engine 204 gathers meeting data from a meeting organizer. In the example of operation of the example system shown in FIG. 2, the meeting management engine 206 generates meeting data, stored in the meeting datastore 208, based on the gather meeting data, indicating meeting attendees that need to be distributed credentials for accessing a wireless network as part of a meeting. Further, in the example of operation of the example system shown in FIG. 2, the credential list management engine 210 generates a credential list based on the meeting data stored in the meeting datastore 208. In the example of operation of the example system shown in FIG. 2, the credential list management engine 210 can store the generated credential list as credential list data stored in the credential list datastore 212 and submit the credential list for use in distributing credentials for access to a wireless network as part of a meeting.

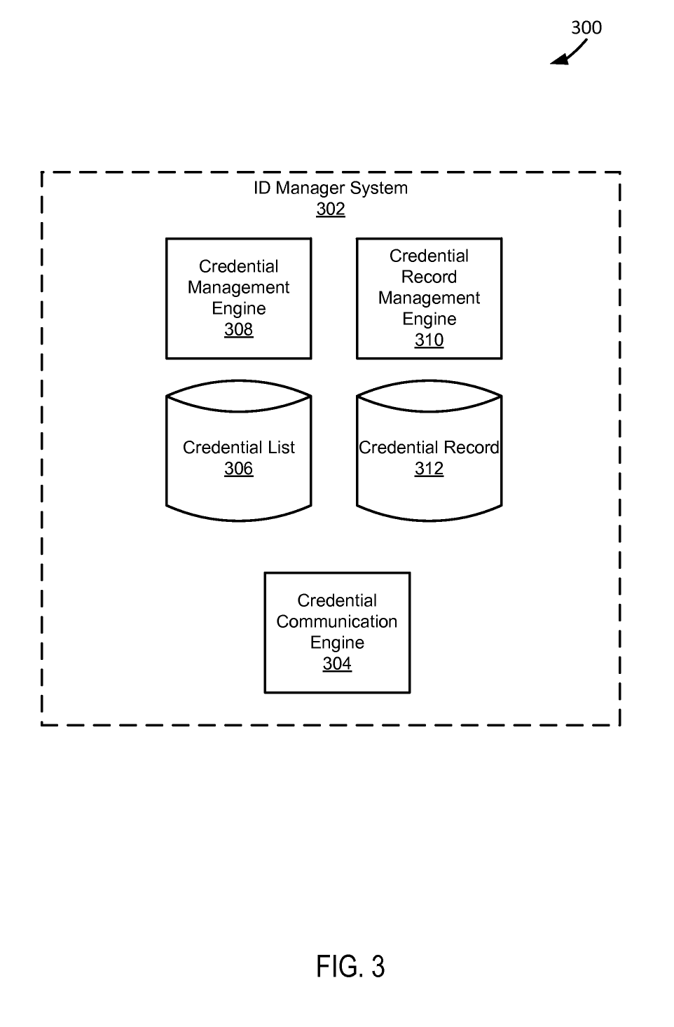

FIG. 3 depicts a diagram 300 of an example of system for managing provisioning of credentials to meeting attendees in accessing a wireless network as part of a meeting. The example system shown in FIG. 3 includes an ID manager system 302. The ID manager system 302 functions according to an applicable system for managing provisioning of credentials to meeting attendees for accessing a wireless network for the meeting, such as the ID manager systems described in this paper. In managing meetings provisioning of credentials, the ID manager system 302 can generate and/or distribute credentials to specific meeting attendees. In various implementations, the ID manager system 302 can generate and/or distribute credentials according to a credential list. Further, in various implementations, the ID manager system 302 can maintain a credential record used, at least in part, to generate and/or distribute credentials to meeting attendees.

In the example system shown in FIG. 3, the ID manager system 302 includes a credential communication engine 304, a credential list datastore 306, a credential management engine 308, a credential record management engine 310, and a credential record datastore 312. The credential communication engine 304 functions to transmit and receive data related to generation and/or distribution of credentials for accessing a wireless network as part of a meeting. The credential communication engine 304 can receive a credential list used in generating and/or distributing credentials to meeting attendees in accessing a wireless network as part of a meeting. For example, the credential communication engine can receive a credential from an applicable system for generating a credential list, such as the IDM exchange manager systems described in this paper. The credential communication engine 304 can send credentials to meeting attendees. For example, the credential communication engine 304 can send credentials to meeting attendees in response to instructions for distributing credentials according to a credential list. In various implementations, the credential communication engine 304 can resend credentials to one or a plurality of meeting attendees in response to instructions to resend credentials.

In a specific implementation, the credential communication engine 304 functions to verify that credentials are distributed to appropriate meeting attendees. The credential communication engine 304 can verify that credentials are successfully transmitted to meeting attendees. In verifying that credentials are successfully transmitted, the credential communication engine 304 can verify that one or a plurality of packets including the credentials are successfully transmitted to a specific meeting attendee. Depending upon implementation-specific or other considerations, the credential communication engine can send confirmation that a credential has been received by a meeting attendee to a meeting organizer.

The credential list datastore 306 functions to store credential list data indicating a credential list. A credential list indicated by credential list data stored in the credential list datastore 306 can be generated by an applicable system for generating a credential list, such as the IDM exchange manager systems described in this paper. A credential list indicated by credential list data stored in the credential list datastore 306 can be used to distribute credentials to meeting attendees for accessing a wireless network as part of a meeting.

The credential management engine 308 functions to manage distribution of credentials according to a credential list. In managing distribution of credentials, the credential management engine 308 can send instructions to an applicable communication engine, such as the credential communication engines described in this paper, indicating to distribute or redistribute credentials to meeting attendees according to a credential list. In various implementations, the credential management engine 308 can generate and send instructions to distribute credentials as soon as a credential list for a meeting is received. Depending upon implementation-specific or other considerations, the credential management engine 308 can send instructions to resend credentials to a meeting attendee based on instructions received from an applicable system for managing a meeting, such as the IDM exchange manager systems described in this paper. For example, if instructions indicating to resend credentials are received by the credential management engine 308 in response to input from a meeting organizer, then the credential management engine 308 can instruct an applicable engine, such as the credential communication engine 304 to resend credentials to a meeting attendee.

In a specific implementation, the credential management engine 308 functions to set a validity length of credentials distributed to meeting attendees. Depending upon implementation-specific or other considerations, the credential management engine 308 can set a credential validity length based on a meeting. For example, the credential management engine 308 can set a validity length of credentials as the entire length of a scheduled time of a meeting. Further depending upon implementation-specific or other considerations, the credential management engine 308 can set a credential validity length based on input received from a meeting organizer. For example, if a meeting organizer specifies that a credential validity length should be 24 hours, then the credential management engine 308 can set a validity length of credentials at 24 hours.

In a specific implementation, the credential management engine 308 functions to manage credentials according to a credential record. Specifically, the credential management engine 308 can determine whether to distribute credentials to meeting attendees according to a credential record. Depending upon implementation-specific or other considerations, the credential management engine 308 can determine whether to distribute a credential to a meeting attendee based on whether they were previously distributed a credential, as indicated by a credential record. For example, the credential management engine 308 can determine to refrain from distributing a credential to a meeting attendee if a credential was previously distributed to the meeting attendee. Further depending upon implementation-specific or other considerations, the credential management engine 308 can determine whether to distribute a credential to a meeting attendee based on whether the meeting attendee has a valid credential, as indicated by a credential record. For example, the credential management engine 308 can determine to distribute a credential to a meeting attendee if the meeting attendee has an expired credential.

The credential record management engine 310 functions to manage credential records of distributed credentials to meeting attendees. In managing credential records, the credential record management engine 310 can create credential record data indicating a credential record for distributed credentials. The credential record management engine 310 can create a credential record indicating which credentials are distributed to which meeting attendees, which meetings the credentials were distributed for, when the credentials were distributed, and a validity length of the credentials. The credential record management engine 310 can manage credential records according to credentials that are distributed to meeting attendees and characteristics of the distributed credentials. For example, if a credential set to expire in 24 hours is sent to a meeting attendee, then the credential record management engine 310 can update a credential record to indicate that the credential was distributed to the meeting attendee and is set to expire in 24 hours.

The credential record datastore 312 functions to store credential record data indicating credential records. The credential record datastore 312 can store credential record data indicating a credential record that includes which credentials are distributed to which meeting attendees, which meetings the credentials were distributed for, when the credentials were distributed, and a validity length of the credentials. Credential records data stored in the credential record datastore 312 can be used in the distribution of credentials to meeting attendees for accessing a wireless network as part of a meeting.

In an example of operation of the example system shown in FIG. 3, the credential communication engine 304 receives a credential list stored as credential data in the credential list datastore 306. In the example of operation of the example system shown in FIG. 3, the credential management engine 308 instructs the credential communication engine 304 to distribute credentials to meeting attendees according to the credential list. Further, in the example of operation of the example system shown in FIG. 3, the credential record management engine 310 maintains a credential record stored as credential record data in the credential record datastore 312, based on the distribution of the credentials by the credential communication engine 304.

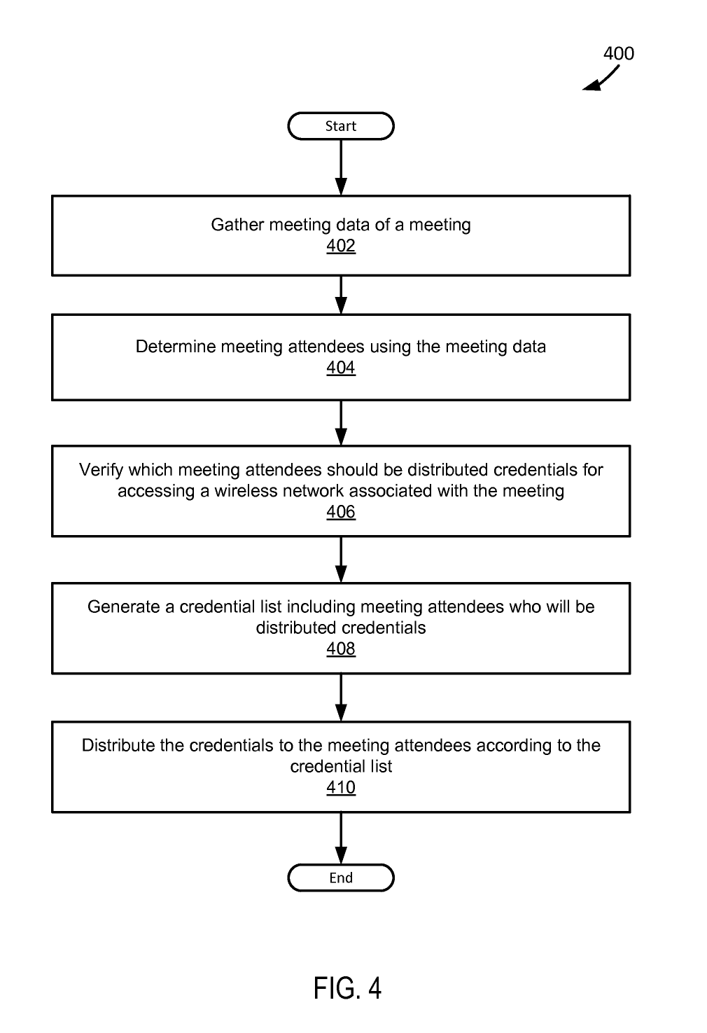

FIG. 4 depicts a diagram of a flowchart 400 of an example method for distributing credentials to meeting attendees for accessing a wireless network associated with a meeting. The flowchart 400 begins at module 402, where meeting data of a meeting is gathered. Meeting data can be gathered by an applicable engine for gathering meeting data for use in distributing credentials, such as the meeting communication engines described in this paper. Depending upon implementation-specific or other considerations, meeting data can be gathered by accessing an email of a meeting organizer. For example meeting data can be gathered based on meeting invitees who reply back to a meeting organizer that they will attend a meeting. Further depending upon implementation-specific or other considerations, meeting data can be gathered by querying a meeting organizer. For example, a meeting organizer can be asked which invitees will attend a meeting.

The flowchart 400 continues to module 404, where meeting attendees are of the meeting are determined using the meeting data. An applicable engine for determining meeting attendees, such as the meeting management engines described in this paper, can determine meeting attendees of the meeting using the meeting data. Depending upon implementation-specific or other considerations, a list of all invitees can be generated from the meeting data and a meeting organizer can be queried as to which invitees will attend the meeting. Additionally, in determining meeting attendees, contact information of meeting attendees can be determined. For example, a MAC address of a meeting attendee's device can be determined.

The flowchart 400 continues to module 406, where which meeting attendees to distribute credentials to is verified. An applicable engine for verifying meeting attendees, such as the meeting management engines described in this paper, can verify which meeting attendees should be distributed credentials. Which meeting attendees to distribute credentials to can be verified by communicating with a meeting organizer. For example, queries can be sent to a meeting organizer with links that upon activation indicate deny requests for denying distribution of credentials to specific meeting attendees.

The flowchart 400 continues to module 408, where a credential list including meeting attendees to distribute credentials to is generated. An applicable engine for generating a credential list, such as the credential list management engines described in this paper, can generate a credential list including the meeting attendees who will be distributed credentials. The credential list can be created based on the verification of the meeting attendees who will be distributed credentials. A credential list can include an identification of meeting attendees, a validity length of distributed credentials, and a communication method and address for distributing the credentials to the meeting attendees.

The flowchart 400 continues to module 410, where the credentials are distributed to the meeting attendees according to the credential list. An applicable system for distributing credentials, such as the ID manager systems described in this paper, can distribute the credentials to the meeting attendees according to the credential list. In distributing the credentials according to the credential list, the credentials can be distributed to the specific meeting attendees included in the credential list.

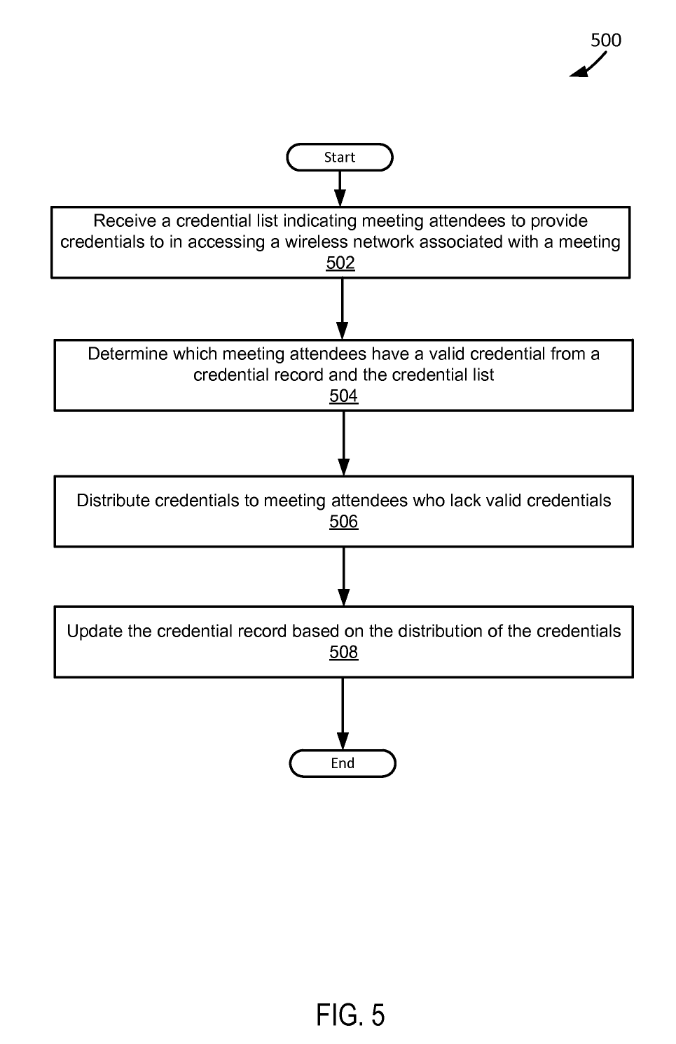

FIG. 5 depicts a diagram of a flowchart 500 of an example method for distributing credentials to meeting attendees for accessing a wireless network associated with a meeting using a credential record. The flowchart 500 begins at module 502, where a credential list is received. An applicable engine for receiving a credential list, such as the credential communication engines described in this paper, can receive a credential list. A credential list can be received from an applicable system for generating a credential list, such as the IDM exchange manager systems described in this paper. A received credential list can indicate meeting attendees to provide credentials to in accessing a wireless network associated with a meeting.

The flowchart 500 continues to module 504, where which meeting attendees have a valid credential is determined from a credential record. An applicable system for determining if meeting attendees have valid credentials, such as the credential management engines described in this paper, can determine which meeting attendees have a valid credential from a credential record. Additionally, a validity length of credentials that will be distributed according to the credential list can be determined. Further, instructions can be generated indicating to distribute credentials to the meeting attendees who lack valid credentials

The flowchart 500 continues to module 506, where credentials are distributed to meeting attendees who lack valid credentials. An applicable engine for distributing credentials, such as the credential communication engines described in this paper, can distribute the credentials to meeting attendees who lack valid credentials. The credentials can be distributed in response to instructions indicating to distribute credentials to the meeting attendees who lack valid credentials.

The flowchart 500 continues to module 508, where the credential record is updated based on the distribution of the credentials. An applicable engine for managing a credential record, such as the credential record management engines described in this paper, can update the credential record based on the distribution of the credentials. The credential record can be updated to include which meeting attendees were distributed credentials and a validity length of the credentials.

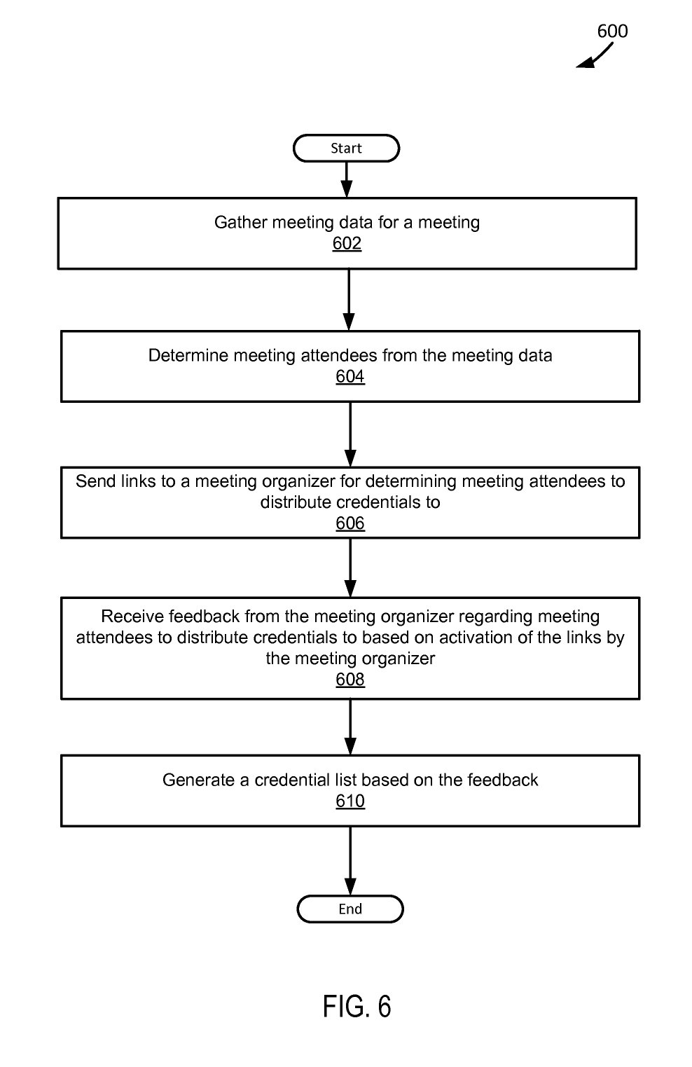

FIG. 6 depicts a flowchart 600 of an example of a method for generating a credential list based on feedback from a meeting organizer for the purposes of providing credentials to meeting attendees in accessing a wireless network as part of a meeting. The flowchart 600 begins at module 602, where meeting data is gathered for a meeting. Meeting data can be gathered by an applicable engine for gathering meeting data for use in distributing credentials, such as the meeting communication engines described in this paper. Depending upon implementation-specific or other considerations, meeting data can be gathered by accessing an email of a meeting organizer. For example meeting data can be gathered based on meeting invitees who reply back to a meeting organizer that they will attend a meeting. Further depending upon implementation-specific or other considerations, meeting data can be gathered by querying a meeting organizer. For example, a meeting organizer can be asked which invitees will attend a meeting.

The flowchart 600 continues to module 604, where meeting attendees of the meeting are determined using the meeting data. An applicable engine for determining meeting attendees, such as the meeting management engines described in this paper, can determine meeting attendees of the meeting using the meeting data. Depending upon implementation-specific or other considerations, a list of all invitees can be generated from the meeting data and a meeting organizer can be queried as to which invitees will attend the meeting. Additionally, in determining meeting attendees, contact information of meeting attendees can be determined. For example, a MAC address of a meeting attendee's device can be determined.

The flowchart 600 continues to module 606, where links are sent to a meeting organizer for determining meeting attendees to distribute credential to in accessing a wireless network as part of the meeting. An applicable engine for generating links to a meeting attendee, such as the meeting management engines described in this paper, can generate links that can be sent to a meeting attendee for purposes of credential distribution. Links sent to a meeting attendee can include an identification of a meeting attendee and an actionable link that upon activation indicates whether to distribute credential to a specific meeting attendee.

The flowchart 600 continues to module 608, where feedback is received from a meeting organizer regarding meeting attendees to distribute credentials to for purposes of accessing a wireless network as part of the meeting. An applicable engine for receiving feedback from a meeting attendee, such as the meeting management engines described in this paper, can receive feedback from a meeting organizer regarding credential distribution. Feedback can be generated by a meeting organizer by activating the links send to the meeting organizer.

The flowchart 600 continues to module 610, where a credential list is generated based on the feedback. An applicable engine for generating a credential list, such as the credential list management engines described in this paper, can generate a credential list based on the feedback. A credential list can be generated based on a list of meeting attendees to distribute credential to, as included as part of meeting data, generate in response to the feedback. A credential list can be used to distribute credential to meeting attendees for purposes of accessing a wireless network as part of a meeting.

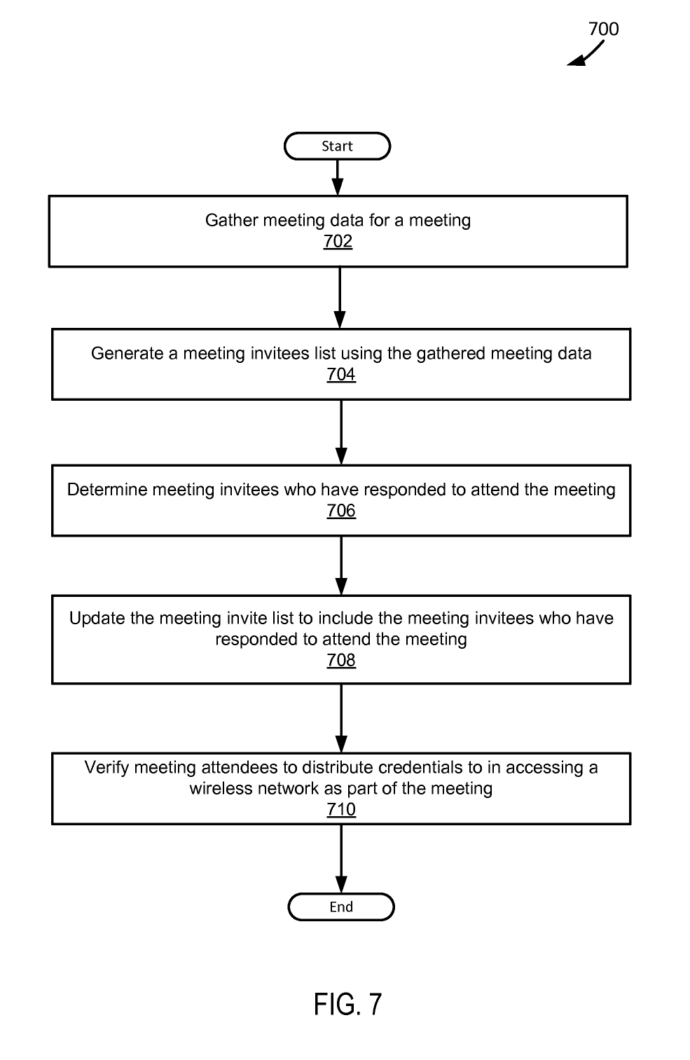

FIG. 7 depicts a flowchart 700 of an example of a method for verifying meeting attendees to distribute credentials to for purposes of accessing a wireless network as part of a meeting. The flowchart 700 begins at module 702, where meeting data for a meeting is gathered. Meeting data can be gathered by an applicable engine for gathering meeting data for use in distributing credentials, such as the meeting communication engines described in this paper. Depending upon implementation-specific or other considerations, meeting data can be gathered by accessing an email of a meeting organizer. Further depending upon implementation-specific or other considerations, meeting data can be gathered by querying a meeting organizer.

The flowchart 700 continues to module 704, where a meeting invitee list is generated using the gathered meeting data. An applicable engine for managing a meeting, such as the meeting management engines described in this paper, can generate a meeting invite list using the gathered meeting data. Depending upon implementation-specific or other considerations, a meeting invite list can be generated by accessing an email account of a meeting organizer. For example, a meeting email account of a meeting organizer can be accessed to determine individuals to which meeting invites were sent. Further depending upon implementation-specific or other considerations, a meeting invite list can be generated by querying a meeting organizer. For example, a meeting organizer can be asked which specific individuals were invited to a meeting.

The flowchart 700 continues to module 706, where meeting invitees who have responded to attend the meeting are determined. An applicable engine for managing a meeting, such as the meeting management engines described in this paper, can determine meeting invitees who have responded to attend the meeting. Depending upon implementation-specific or other considerations, meeting invitees who have responded to attend a meeting can be determined by accessing an email account of a meeting organizer. For example, a meeting email account of a meeting organizer can be accessed to determine individuals who have responded as indicating that they will attend a meeting. Further depending upon implementation-specific or other considerations, meeting invitees who have responded to attend a meeting can be determined by querying a meeting organizer. For example, a meeting organizer can be asked which specific individuals have responded to attend a meeting.

The flowchart 700 continues to module 708, where the meeting invitee list is updated based on the meeting invitees who have responded to attend the meeting to create a meeting attendee list. An applicable engine for managing a meeting, such as the meeting management engines described in this paper, can update a meeting attendee list based on meeting invitees who have responded to attend the meeting. For example, the meeting invite list can be updated to remove meeting invitees who have not responded to attend the meeting to create a meeting attendee list.

The flowchart 700 continues to module 710 where, meeting attendees to distribute credentials to in accessing a wireless network as part of the meeting are verified. An applicable engine for verifying meeting attendees, such as the meeting management engines described in this paper, can verify which meeting attendees should be distributed credentials. Which meeting attendees to distribute credentials to can be verified by communicating with a meeting organizer. For example, queries can be sent to a meeting organizer with links that upon activation indicate deny requests for denying distribution of credentials to specific meeting attendees.

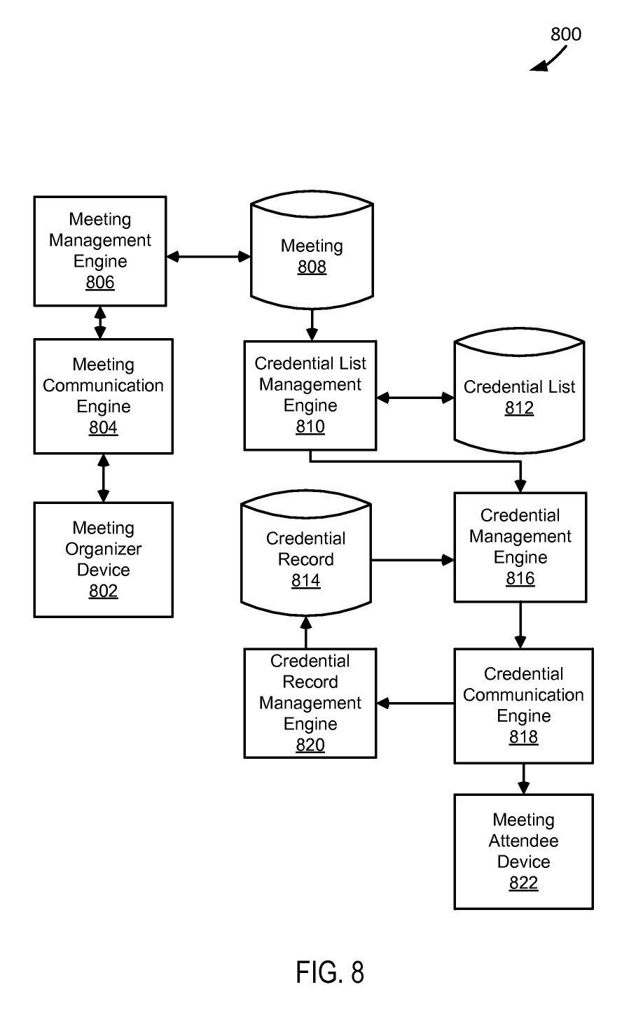

FIG. 8 depicts a diagram 800 of an example of a system for distributing credentials to meeting attendees for use in accessing a wireless network as part of a meeting. The example system shown in FIG. 8 includes a meeting organizer device 802, a meeting communication engine 804, a meeting management engine 806, a meeting datastore 808, a credential list management engine 810, a credential list datastore 812, a credential record datastore 814, a credential management engine 816, a credential communication engine 818, a credential record management engine 820, and a meeting attendee device 822.

The meeting organizer device 802 functions according to an applicable device for sending and receiving data in scheduling a meeting by a meeting organizer, such as the meeting organizer devices described in this paper. The meeting organizer device 802 can be used to access an email of a meeting organizer. In accessing an email account of a meeting organizer, a meeting organizer can send meeting invites to meeting invitees and receive confirmation of attendance. Depending upon implementation-specific or other considerations, the meeting organizer device 802 can be used to calendar a meeting for a meeting organizer. For example, the meeting organizer device 802 can be used to input into a calendar of a meeting organizer a time and a place of a meeting organized by a meeting organizer.

The meeting communication engine functions according to an applicable engine for communicating with a meeting organizer device, such as the meeting communication engines described in this paper. The meeting communication engine 804 can be used to gather meeting data. Depending upon implementation-specific or other consideration, the meeting communication engine 804 can gather meeting data from the meeting organizer device 804. For example, the meeting communication engine 804 can access an email account of a meeting organizer to collect meeting data about a meeting scheduled by the meeting organizer. Further depending upon implementation-specific or other considerations, the meeting communication engine 804 can query a meeting organizer to collect meeting data. For example, the meeting communication engine 804 can query a meeting organizer to indicate which meeting attendees should be distributed credentials.

The meeting management engine 806 functions according to an applicable engine for managing meetings for the purpose of providing credentials to meeting attendees, such as the meeting management engines described in this paper. Depending upon implementation-specific or other considerations, in managing a meeting for the purpose of providing credential meeting attendees, the meeting management engine 806 can generate a list of meeting invitees from meeting data collected by the meeting communication engine 804. For example, the meeting management engine 806 can use meeting data collected from an email account of a meeting organizer to determine meeting invitees. Further depending upon implementation-specific or other considerations, the meeting management engine 806 can generate a list of meeting attendees from meeting data collected by the meeting communication engine 804. For example, the meeting management engine 806 can use meeting data collected from an email account of a meeting organizer to determine invitees who have confirmed that they will attend a meeting. Depending upon implementation-specific or other considerations, the meeting management engine 806, can query a meeting organizer, through the meeting communication engine 804, regarding meeting attendees who should be distributed credentials. For example, the meeting management engine 806 can send, through the meeting communication engine 804, links that upon activation indicate to distribute credentials to a specific meeting attendee for accessing a wireless network.

The meeting datastore 808 functions according to an applicable datastore for storing meeting data, such as the meeting datastores described in this paper. The meeting datastore 808 can store meeting data collected by the meeting communication engine 804. For example, the meeting datastore 808 can store meeting data indicating invitees to a meeting, as collected by the meeting communication engine 804. The meeting datastore 808 can store meeting data indicating a list of meeting attendees to distribute credentials to, as determined by the meeting management engine 806.

The credential list management engine 810 functions according to an applicable engine for managing a credential list for distributing credentials used in accessing a wireless network associated with a meeting, such as the credential list management engines described in this paper. The credential list management engine 810 can use meeting data stored in the meeting datastore 808 to generate a credential list indicating meeting attendees to send credentials to in accessing a wireless network associated with a meeting. For example, the credential list management engine can use meeting data indicating meeting attendees to distribute credentials to, to generate a credential list. The credential list management engine 810 can store a credential list as part of credential list data stored in the credential list datastore 812. For example, the credential list datastore 812 can store credential list data indicating meeting attendees to distribute credentials to in accessing a wireless network as part of a meeting.

In a specific implementation, the credential list management engine 810 functions to submit a credential list for use in managing credentials used in accessing a wireless network as part of a meeting, such as the ID manager systems described in this paper. Depending upon implementation-specific or other considerations, the credential list management engine 810 can submit a credential list at a set time. For example, the credential list management engine 810 can submit a credential list 15 minutes before a meeting is scheduled to take place. Further depending upon implementation-specific or other considerations, the credential list management engine 810 can submit a credential list after occurrence of a specific event. For example, the credential list management engine 810 can submit a credential list after all invitees to a meeting have either accepted or denied an invitation to the meeting.

The credential record datastore 814 functions according to an applicable datastore for storing credential record data, such as the credential record datastores described in this paper. The credential record datastore 814 can store credential record data indicating a credential record that includes which credentials are distributed to which meeting attendees, which meetings the credentials were distributed for, when the credentials were distributed, and a validity length of the credentials.

The credential management engine 816 functions according to an applicable engine for managing distribution of credentials according to a credential list, such as the credential management engines described in this paper. In managing distribution of credentials, the credential management engine 816 can send instructions indicating to distribute or redistribute credentials to meeting attendees according to a credential list. In various implementations, the credential management engine 816 can generate and send instructions to distribute credentials as soon as a credential list for a meeting is received. Depending upon implementation-specific or other considerations, the credential management engine 816 can send instructions to resend credentials to a meeting attendee. For example, if instructions indicating to resend credentials are received by the credential management engine 816 in response to input from a meeting organizer, then the credential management engine 816 can instruct an applicable engine to resend credentials to a meeting attendee.

In a specific implementation, the credential record management engine 816 functions to manage credentials according to a credential record. Specifically, the credential management engine 816 can determine whether to distribute credentials to meeting attendees according to a credential record stored in the credential record datastore 814. Depending upon implementation-specific or other considerations, the credential management engine 816 can determine whether to distribute a credential to a meeting attendee based on whether they were previously distributed a credential, as indicated by a credential record. For example, the credential management engine 816 can determine to refrain from distributing a credential to a meeting attendee if a credential was previously distributed to the meeting attendee. Further depending upon implementation-specific or other considerations, the credential management engine 816 can determine whether to distribute a credential to a meeting attendee based on whether the meeting attendee has a valid credential, as indicated by a credential record. For example, the credential management engine 816 can determine to distribute a credential to a meeting attendee if the meeting attendee has an expired credential.

The credential communication engine 818 functions according to an applicable system for distributing credentials, such as the credential communication engines described in this paper. The credential communication engine 818 can receive a credential list used in generating and/or distributing credentials to meeting attendees in accessing a wireless network as part of a meeting. For example, the credential communication engine can receive a credential list from the credential management engine 816. The credential communication engine 818 can send credentials to meeting attendee devices, such as the meeting attendee device 822. For example, the credential communication engine 816 can send credentials to meeting attendees in response to instructions for distributing credentials according to a credential list. In various implementations, the credential communication engine 816 can resend credentials to one or a plurality of meeting attendees in response to instructions to resend credentials.

The credential record management engine 820 functions according to an applicable engine for managing a credential record, such as the credential record management engines described in this paper. In managing credential records, the credential record management engine 820 can create credential record data stored in the credential record datastore 814, indicating a credential record for distributed credentials. The credential record management engine 820 can create a credential record indicating which credentials are distributed to which meeting attendees, which meetings the credentials were distributed for, when the credentials were distributed, and a validity length of the credentials. The credential record management engine 820 can manage credential records according to credentials that are distributed to meeting attendees by the credential communication engine 818 and characteristics of the distributed credentials. For example, if a credential set to expire in 24 hours is sent to a meeting attendee, then the credential record management engine 820 can update a credential record to indicate that the credential was distributed to the meeting attendee and is set to expire in 24 hours.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
gathering meeting data regarding a meeting;
determining a plurality of meeting attendees of the meeting from the meeting data;
verifying meeting attendees of the plurality of meeting attendees to which to distribute credentials for accessing a wireless network as part of the meeting;
creating a credential list indicating the meeting attendees to which to distribute the credentials for accessing a wireless network as part of the meeting;
submitting the credential list;
distributing the credentials to the meeting attendees using the credential list.

2. The method of claim 1, wherein the meeting data is gathered through an email account of a meeting organizer.

3. The method of claim 1, wherein the credential list includes contact information of the meeting attendees.

4. The method of claim 1, wherein the credential list is submitted at a specific time before the meeting begins.

5. The method of claim 1, further comprising:
determining if at least one meeting attendee of the meeting attendees already has a valid credential from a credential record;
if it is determined that the at least one meeting attendee of the meeting attendees already has the valid credential, refraining from distributing a credential to the at least one meeting attendee.

6. The method of claim 1, further comprising updating a credential record based on distribution of the credentials to the meeting attendees, the credential record including a time when the credentials were distributed to the meeting attendees, an identification of the meeting attendees, and a validity length of the credentials.

7. The method of claim 1, wherein verifying the meeting attendees of the plurality of meeting attendees further comprises querying a meeting organizer with links that when activated generate input indicating to deny distribution of credentials to specific meeting attendees of the meeting attendees.

8. The method of claim 1, further comprising determining validity length of the credentials distributed to the meeting attendees, the validity length determined based on a length of time of the meeting.

9. The method of claim 1, further comprising determining validity length of the credentials distributed to the meeting attendees, the validity length determined based on input from a meeting organizer.

10. The method of claim 1, further comprising:
querying a meeting organizer as to whether to redistribute the credentials to specific meeting attendees of the meeting attendees;
redistributing the credentials to the specific meeting attendees if the meeting organizer indicates to redistribute the credentials.

11. A system comprising:
a meeting communication engine configured to gather meeting data regarding a meeting;
a meeting management engine configured to:
determine a plurality of meeting attendees of the meeting from the meeting data;
verify meeting attendees of the plurality of meeting attendees to which to distribute credentials for accessing a wireless network as part of the meeting;
a credential list management engine configured to:
create a credential list indicating the meeting attendees to which to distribute the credentials for accessing a wireless network as part of the meeting;
submit the credential list;
a credential communication engine configured to distribute the credentials to the meeting attendees using the credential list submitted by the credential list management engine.

12. The system of claim 11, wherein the meeting data is gathered by the meeting communication engine through an email account of a meeting organizer.

13. The system of claim 11, wherein the credential list includes contact information of the meeting attendees.

14. The system of claim 11, wherein the credential list management engine is further configured to submit the credential list at a specific time before the meeting begins.

15. The system of claim 11, further comprising a credential management engine configured to:
determine if at least one meeting attendee of the meeting attendees already has a valid credential from a credential record;
send instructions to the credential communication engine to refrain from distributing a credential to the at least one meeting attendee if it is determined that the at least one meeting attendee of the meeting attendees already has the valid credential.

16. The system of claim 11, further comprising a credential record management engine configured to update a credential record based on distribution of the credentials to the meeting attendees, the credential record including a time when the credentials were distributed to the meeting attendees, an identification of the meeting attendees, and a validity length of the credentials.

17. The system of claim 11, wherein the meeting management engine is further configured to query a meeting organizer with links that when activated generate input indicating to deny distribution of credentials to specific meeting attendees of the meeting attendees.

18. The system of claim 11, further comprising a credential management engine configured to determine validity length of the credentials distributed to the meeting attendees, the validity length determined based on a length of time of the meeting.

19. The system of claim 11, further comprising a credential management engine configured to determine validity length of the credentials distributed to the meeting attendees, the validity length determined based on input from a meeting organizer.

20. A system comprising:
means for gathering meeting data regarding a meeting;
means for determining a plurality of meeting attendees of the meeting from the meeting data;
means for verifying meeting attendees of the plurality of meeting attendees to which to distribute credentials for accessing a wireless network as part of the meeting;
means for creating a credential list indicating the meeting attendees to which to distribute the credentials for accessing a wireless network as part of the meeting;
means for submitting the credential list;
means for distributing the credentials to the meeting attendees using the credential list.
